(19) United States
(12) Patent Application Publication
(10) Pub. No.: US 2009/0144445 A1
(43) Pub. Date: Jun. 4, 2009

(54) METHOD FOR TRANSMITTING MESSAGES

(75) Inventors: Andries Van Wageningen, Wijlre (NL); Peter Fuhrmann, Aachen (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/996,971

(22) PCT Filed: Jul. 31, 2006
(86) PCT No.: PCT/IB2006/052608

§ 371 Date: Aug. 14, 2008

(30) Foreign Application Priority Data
Aug. 9, 2005 (EP) 05107312.0
Jul. 31, 2006 (IB) PCT/IB2006/052608

(51) Int. Cl. G06F 15/16

(52) U.S. Cl. 709/239

(57) ABSTRACT

In order to provide a method for transmitting messages between a number of nodes (1, 2, 3, 4) of a network over two channels (A, B) which ensures reliable message transmission even in the event of a failure of one of the two channels (A, B), it is proposed that, in the event of a failure of one channel (A, B), messages are transmitted over the other channel (B, A).

The invention relates to a method for transmitting messages between a number of nodes of a network over two channels.

In various fields of technology, it is necessary to exchange messages or information preferably in the form of data packets between a number of nodes of a network, in order for example to control and monitor complicated technical devices comprising a number of sensors for variable parameters and control elements for influencing these parameters. In particular, such networks for mutual data exchange are used in the motor vehicle industry, for example to transmit information from various sensors such as speed and/or acceleration sensors to a host for controlling all the functions of the motor vehicle and to make it possible to activate an airbag for example if a maximum permitted acceleration value is exceeded.

In this case, it is necessary for data or messages to be reliably exchanged between the nodes which form the network. This exchange of information usually takes place via electrical wires and/or via fiberoptic cables. These connections, which are also referred to as channels, can be damaged by external influences or message transmission can be restricted by corroded connections. In such a case, message transmission would become impossible. In order to prevent failure of the connection, particularly if safety-related data are to be exchanged, it is known to use two parallel channels for data transmission, to which each node of the network is respectively connected. In this case, usually at least the safety-related data are transmitted in parallel over both channels, so that, in the event of failure of one channel, the safety-related information is still transmitted over the other channel. However, this doubling of the amount of data requires double the bandwidth in each channel for message transmission. This is often associated with additional costs for improved lines.

U.S. Pat. No. 4,973,953 describes a data transmission system for message transmission between a number of nodes. In this case, each node is respectively connected to its two neighboring nodes via two channels for message transmission. This means that, in the event of a failure of a channel between two neighboring nodes, message transmission between nodes that are far away from one another is also impaired since now all the messages can be transmitted over just a single channel.

U.S. Pat. No. 5,329,521 describes a method for operating a redundant local network. In this case, the nodes of the network are respectively assigned connection devices in order to be able to transmit messages via the latter. Further redundant adapters are used to select a specific connection, in order to be able to select one of the connections in each case. This requires a high outlay in terms of circuit technology and programming technology.

The object of the invention is to provide a method for transmitting messages between a number of nodes of a network over two channels, which reliably ensures data exchange between the nodes even in the event of failure of one of the two channels.

This object is achieved by the features specified in claim 1.

The core concept of the invention consists in that, in the event of a failure of one channel, the messages or data which are usually transmitted over this channel are additionally transmitted or transferred over the other channel. It will be understood here that the network or system for message transmission which consists of nodes and channels is also assigned means for ascertaining a failure of a channel for message transmission, and wherein these means are designed in such a way that they can transmit corresponding signals for example to a central computer or host which accordingly causes messages or data to be transmitted over the other channel. Another possibility is to distribute the corresponding signals over the system in such a way that each affected node is informed about the current state of the connections. The nodes can then make the decision, by joint agreement, to transmit the data on the other channel.

Hereinbelow, terms are defined which will be used to explain the invention in greater detail:

R connections:
Connections for which message or data transmission can be rearranged from one channel to the other;
R data value:
Data value of an R connection. These data values can be assigned either to the messages or directly to the frames;
R messages:
Messages which are assigned only R data values and no other types of data value;

### Message ID:

Identification field of a message, e.g. in accordance with the FlexRay data transmission format (known per se) or the CAN protocol;
R frame:
Frame which is assigned and transmits only R messages or R data values;
R-Tx buffer memory, R-Rx buffer memory:
Buffer memories which receive all the data and for which associated control data exist, in order to transmit the frame over the associated channel and in accordance with the respective identification signal; Tx stands for transmission, Rx for reception.

It is obvious to the person skilled in the art that this method is used in particular for the CAN protocol (known per se) and preferably for the dynamic part of the FlexRay protocol. Since, for both systems, the frame identification signal defines the priority for access to the transmission medium, that is to say the channel, less important connections are replaced by connections of higher priority if just a limited bandwidth is available for the single remaining channel. This could lead for example to the situation where other connections are no longer maintained if all R connections have to be maintained over a single channel.

Preferred embodiments of the invention form the subject matter of dependent claims.

According to claim 2, not all messages or data to be transmitted in the network are formatted in such a way that they can be transmitted on both channels. Thus, in the event of a failure of one channel, in particular only the safety-related data are transmitted on the channel which is still intact.

In one preferred embodiment, according to claim 3, each of the plurality of nodes of the network is assigned buffer memories, namely R-Tx and R-Rx buffer memories, for storing data to be transmitted and received, respectively. A set of frame identification signals is reserved in each channel in order to be able to transmit all the data of the R connections. At the same time, the number of R frame identification signals in channel A is equal to the number of these identification signals in channel B. Likewise, each identification signal in channel A has an equivalent identification signal in channel B, and vice versa.

In order to be able to transmit the data either on channel A or channel B, the messages are assigned to the frame identification signals on channel A in the same way as on channel B.

In order to make the transfer of messages to be transmitted from one channel to the other as simple as possible, it is proposed in claim 4 that, during normal operation of the network, some of the R-Tx buffer memories of channel A and some of the R-Tx buffer memories of channel B are blocked or deactivated, so that, for each R connection, the data are transmitted either on channel A or on channel B. This is controlled by the host of the network or by a distributed algorithm. If channel A should fail, all the R-Tx buffer memories of channel B are enabled or activated in order thus to be able to transmit all the necessary messages over channel B. If channel B should fail, all the R-Tx buffer memories of channel A are activated.

In a simple manner, according to claim 5, during normal operation the Tx buffer memories for the even frame identification signals of channel A and for the odd frame identification signals of channel B are deactivated for transmission. This may of course also be effected inversely. If channel A fails, all the Tx buffer memories of channel B are activated, and vice versa.

In one alternative embodiment which is specified in claim 6, R-Tx message memories and R-Rx message memories are provided in the host for each R connection. The identification of a connection is given by the message identification signal of a message. The message identification signal can be defined as part of the frame format, such as in the FlexRay protocol for example. However, it may also be designed as part of a higher protocol, for example by transmitting a message identification signal as part of the frame. The use of message identification signals permits simpler assignment of messages to frame identification signals. Connections are no longer identified only by the frame identification signal, so that a large number of connections can be provided with the same frame identification signal. In this case, each R connection is implemented on both channels, wherein a set of frame identification signals is reserved in each channel in order to be able to transmit all the data of the R connections. For each channel and each frame identification signal, a Tx buffer memory and an Rx buffer memory is provided in the node. These buffer memories need not be expressly reversed for the R connections, but rather can also be used for other types of connection. Each R connection can be distinguished by the R message identification signal assigned thereto. In normal operation, some of the R-Tx message memories of channel A and some of the R-Tx message memories of channel B are blocked or deactivated. This is controlled by the host of the network or by a distributed algorithm, so that, for each R connection, the data are transmitted either on channel A or on channel B.

Preferably, according to claim 7, in the event of a failure of channel A, all the R-Tx message memories of channel B are enabled or activated, or vice versa.

As mentioned above, this may be effected in a symmetrical manner with the even and odd R-Tx message memories, according to claim 8.

Since a large number of messages can be assigned to the same frame identification signal, the host must make a decision as to which of the messages are copied into the Tx buffer memories if a large number of messages has to be transmitted. This decision as to which of the messages has to be processed or transmitted or copied first may be based on a defined priority classification which is assigned to the connection or to the message, as characterized in claim 9. This priority classification may be defined in advance on the basis of safety-related features for example, so as to ensure that important messages or data are reliably transmitted even if just one channel is available.

Preferably, according to claim 10, the method for transmitting messages between a number of nodes of a network over two channels is used in the motor vehicle sector, for example to network a number of sensors and control and regulating units and a host of the motor vehicle to one another, in order to reliably ensure the mutual exchange of messages, data and signals even in the event of damage to one of the two channels.

The invention will be further described with reference to an example of embodiment shown in the drawing to which, however, the invention is not restricted.

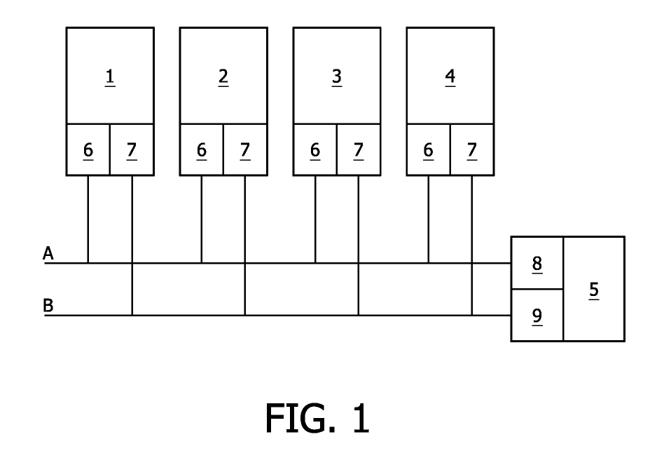

FIG. 1 shows a schematic block diagram of the network.

The basic structure of the network can be seen from the schematic block diagram thereof which is shown in FIG. 1. The network consists of a number of nodes 1, 2, 3, 4, for example sensors in a motor vehicle or the like. The nodes 1, 2, 3, 4 are connected to one another and to a host 5 via two channels A, B. The channels A, B are designed in such a way that the nodes 1, 2, 3, 4 are connected in parallel with the channels A, B.

If one of the two channels A, B fails, for example on account of a mechanical fault, the messages to be transmitted are thus transmitted on the respective other channel B, A. To this end, in a first embodiment, each of the nodes 1, 2, 3, 4 is assigned R-Tx buffer memories 6 and R-Rx buffer memories 7, for storing the messages to be transmitted and the received messages, respectively. In an alternative embodiment, R-Tx message memories 8 and R-Rx message memories 9 may additionally be provided in the host 5.

### LIST OF REFERENCES

1, 2, 3, 4 node
5 host
6 R-Tx buffer memory
7 R-Rx buffer memory
8 R-Tx message memory
9 R-Rx message memory
A, B channel

1. A method for transmitting messages between a number of nodes of a network over two channels, characterized in that, in the event of a failure of one channel, messages are transmitted over the other channel.

2. A method as claimed in claim 1, characterized in that only some of the messages to be transmitted can be transmitted on both channels.

3. A method as claimed in claim 1, characterized in that R-Tx buffer memories and R-Rx buffer memories are assigned to each node.

4. A method as claimed in claim 3, characterized in that the buffer memories are activated or deactivated.

5. A method as claimed in claim 4, characterized in that the even or odd buffer memories activated or deactivated.

6. A method as claimed in claim 1, characterized in that R-Tx message memories and R-Rx message memories are assigned to a host.

7. A method as claimed in claim 6, characterized in that the message memories activated or deactivated.

8. A method as claimed in claim 7, characterized in that the even or odd message memories are activated or deactivated.

9. A method as claimed in Claim 1, characterized in that a priority classification is assigned to a message to be transmitted.

10. The use of a method as claimed in Claim 1 in motor vehicle technology.
